(19) United States
(12) Patent Application Publication
(10) Pub. No.: US 2016/0187284 A1
(43) Pub. Date: Jun. 30, 2016

(54) MULTI-PORE SILICON SUBSTRATE AND BIOTECHNOLOGICAL TEST STRIP WITH THE MULTI-PORE SILICON SUBSTRATE

(71) Applicant: Cheng-Lin Chuang, Jhongli City (TW)

(72) Inventor: Cheng-Lin Chuang, Jhongli City (TW)

(21) Appl. No.: 14/944,226

(22) Filed: Nov. 18, 2015

(30) Foreign Application Priority Data
Dec. 25, 2014 (TW) 103145473

(51) Int. Cl. G01N 27/40; G01N 27/327

(52) U.S. Cl. CPC G01N 27/40; G01N 27/3272

(57) ABSTRACT

A multi-pore silicon substrate and a biotechnological test strip with the multi-pore silicon substrate. The multi-pore silicon substrate includes a main body. The main body has a first side, a second side and multiple pores. The pores pass through the main body, respectively. Two ends of each pore communicate with the first and second sides of the main body. The multi-pore silicon substrate is applied to a biotechnological test strip necessitating the multi-pore silicon substrate. The biotechnological test strip with the multi-pore silicon substrate improves the shortcomings of the conventional in vitro test strip that it is uneasy to manufacture the test strip and the blood filtering effect is poor. Also, the biotechnological test strip with the multi-pore silicon substrate is manufactured at much lower cost and the reservation period of the biotechnological test strip with the multi-pore silicon substrate is prolonged.

This application claims the priority benefit of Taiwan patent application number 103145473 filed on Dec. 25, 2014.

### BACKGROUND OF THE INVENTION

1. Field of the Invention

The present invention relates generally to a multi-pore silicon substrate and a biotechnological test strip with the multi-pore silicon substrate, and more particularly to a passive micrometer/nanometer multi-pore silicon substrate with high aspect ratio. The multi-pore silicon substrate is applied to a biotechnological test strip to overcome the shortcomings of the conventional in vitro test strip.

2. Description of the Related Art

Along with the advance of sciences and technologies, there is a trend that many medical test instruments, such as blood glucose meter, uric acid meter, cholesterol meter or other physiological property testers, are unnecessary to be performed by professional medical workers. Instead, these medical test instruments can be operated to perform the tests by an ordinary nonprofessional person. With respect to a biochemical blood test instrument, it is necessary to first use a substrate to filter off the large molecules in the blood, such as erythrocyte and leucocyte, so as to avoid interference with the test data. By means of such technique, various biochemical data such as blood glucose, uric acid and cholesterol can be obtained through blood test. In addition, when using the blood biochemical analyzer, the blood biochemical analyzer will fix the enzyme between the polycarbonate substrate layer and the acetate fiber substrate layer. The hydrogen peroxide produced from the reaction of the tested analyte and the enzyme will pass through the fiber substrate layer to reach the platinum electrode. The concentration of the tested analyte can be deduced from the reaction current signal of the redox reaction on the electrode. Accordingly, in a common biochemical instrument, several filter layers are used to filter off the large-molecule interference materials so as to reduce the interference and enhance the chemical reaction signal of the tested analyte and the enzyme. However, the multi-pore microstructures of the substrate of the conventional test strip are intersecting irregular mesh textures. The filtering effect achieved by such microstructures is poor and the aid of stronger external force is often needed to achieve a desired filtering effect. In this case, the usage of the substrate is greatly limited. Moreover, the pores of the multi-pore membrane of the test strip for filtering the blood are not through pores, but intersecting pores with irregular shapes. Therefore, when testing and measuring the biochemical data, the blood filtering effect achieved by such test strip is not good. Not only the blood filtering time is long, but also it is time-consuming and laborious to manufacture the test strip. With respect to a common conventional in vitro cholesterol test strip, at least three blood test steps are required to filter off the large-molecule materials and the manufacturing cost for the test strip is quite high. Moreover, after the filter substrate of the conventional in vitro diagnostic test strip has been reserved for over 6-12 months, the filter material will become brittle and cracked. This will lead to great deterioration of the blood filtering effect and lower the precision of the biochemical data.

It is therefore tried by the applicant to provide a multi-pore silicon substrate and a biotechnological test strip with the multi-pore silicon substrate to eliminate the shortcomings of the conventional substrate technique and lower the manufacturing cost for the test strip.

### SUMMARY OF THE INVENTION

It is therefore a primary object of the present invention to provide a multi-pore silicon substrate with high aspect ratio and pores uniformly passing through the silicon substrate.

It is a further object of the present invention to provide the above multi-pore silicon substrate, which is applied to a key component of an instrument for biochemical test having biological anticorrosion requirement. The biotechnological test strip with the multi-pore silicon substrate is manufactured at much lower cost and is able to enhance the test precision.

To achieve the above and other objects, the multi-pore silicon substrate of the present invention includes a main body.

The main body has a first side, a second side and multiple micrometer/nanometer passive matrix geometrical pores. The pores pass through the main body. Two ends of the pores communicate with the first and second sides of the main body.

Still to achieve the above and other objects, the biotechnological test strip with the multi-pore silicon substrate of the present invention includes an upper cover, a multi-pore silicon substrate, an intermediate layer, an electrode layer and a bottom board. The multi-pore silicon substrate includes a main body. The main body has a first side, a second side and multiple pores. The pores pass through the main body, respectively. Two ends of each pore communicate with the first and second sides of the main body. The upper cover has a guide-in section. The upper cover is disposed on upper side of the first side of the multi-pore silicon substrate with the guide-in section aligned with the multi-pore silicon substrate. The intermediate layer has an accommodating section. The multi-pore silicon substrate is disposed in the accommodating section. The intermediate layer is covered by the upper cover and attached to the upper cover. The electrode layer is attached to the intermediate layer. The bottom board covers the electrode layer.

The multi-pore silicon substrate of the present invention provides uniformly distributed pores that fully pass through the multi-pore silicon substrate, respectively, so as to lower the manufacturing cost.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a scanning electronic microscopic view of a preferred embodiment of the multi-pore silicon substrate of the present invention;

FIG. 2 is another scanning electronic microscopic view of the preferred embodiment of the multi-pore silicon substrate of the present invention;

FIG. 3 is a scanning electronic microscopic sectional view of the preferred embodiment of the multi-pore silicon substrate of the present invention;

FIG. 4 is a perspective exploded view of a preferred embodiment of the biotechnological test strip with the multi-pore silicon substrate of the present invention; and

FIG. 5 is a sectional assembled view of the preferred embodiment of the biotechnological test strip with the multi-pore silicon substrate of the present invention.

### DETAILED DESCRIPTION OF THE PREFERRED EMBODIMENTS

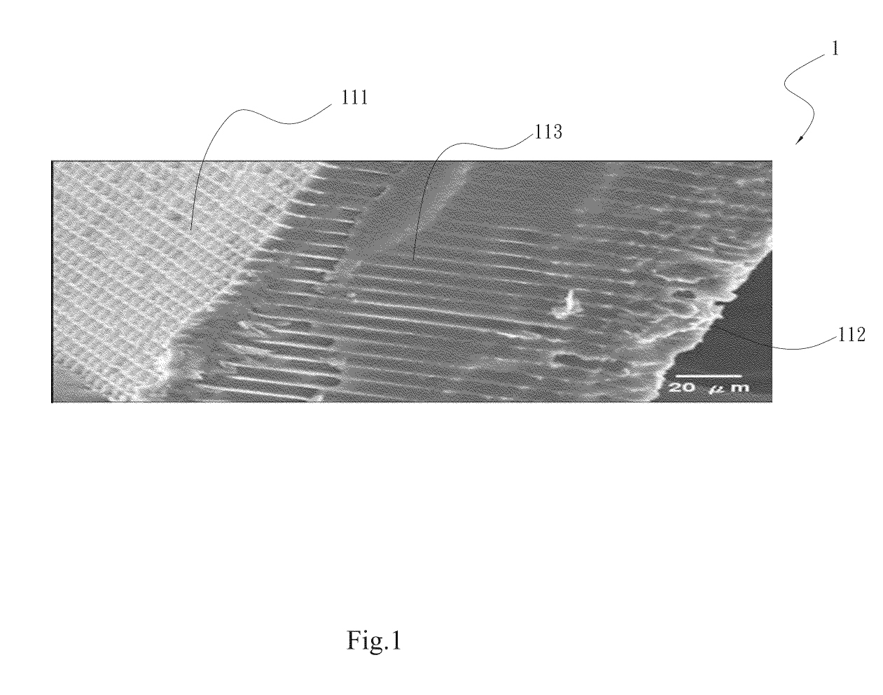

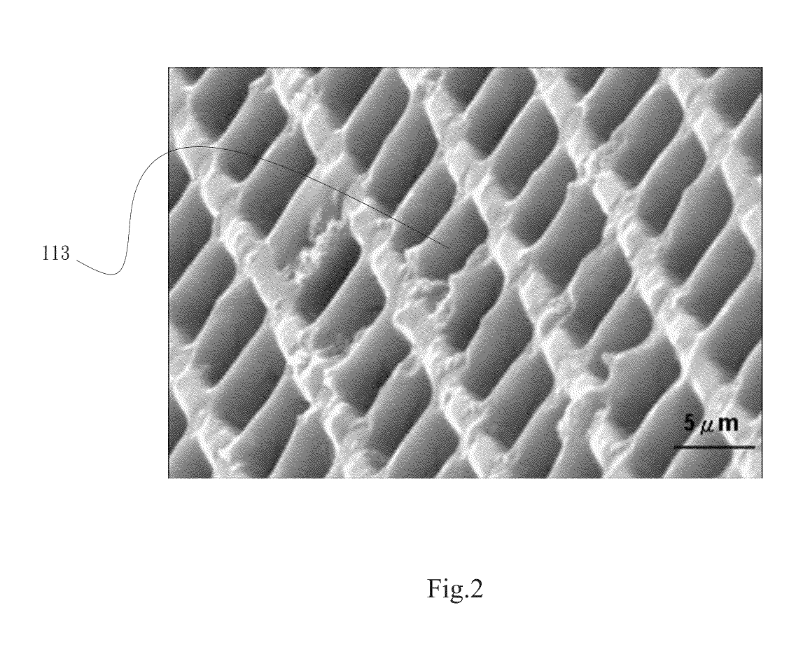

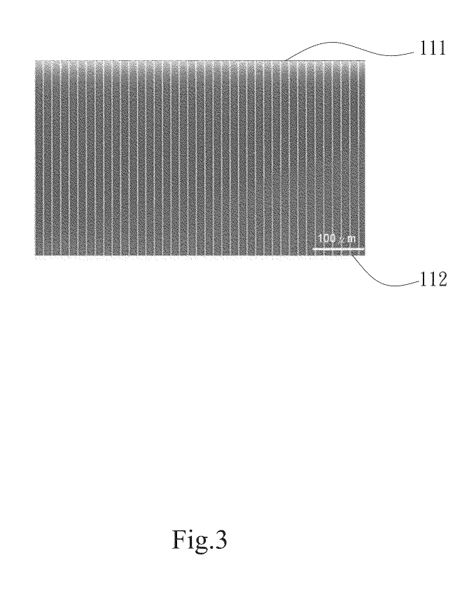

Please refer to FIGS. 1, 2 and 3. FIG. 1 is a scanning electronic microscopic view of a preferred embodiment of the multi-pore silicon substrate of the present invention. FIG. 2 is another scanning electronic microscopic view of the preferred embodiment of the multi-pore silicon substrate of the present invention. FIG. 3 is a scanning electronic microscopic cross-section view of the preferred embodiment of the multi-pore silicon substrate of the present invention. As shown in the drawings, the multi-pore silicon substrate 1 of the present invention includes a main body 11 having a first side 111, a second side 112 and multiple pores 113. Each pore 113 passes through the main body 11 between the first and second sides 111, 112. Two ends of the pore 113 communicate with the first and second sides 111, 112 of the main body 11. The diameter of each pore 113 is in micrometer order or nanometer order. In this embodiment, the diameter of the pore 113 is, but not limited to, in micrometer order for illustration purposes. Alternatively, the pores 113 can have a smaller diameter according to the precision required in a use situation. The pores 113 are formed by means of etching and electrochemical polishing processes. The multi-pore silicon substrate 1 is made of a passive material selected from a group consisting of glass, silicon and common biocompatible silicon-based material.

The multi-pore silicon substrate 1 is a polycrystalline silicon substrate or a monocrystalline silicon substrate. In this embodiment, the multi-pore silicon substrate 1 is, but not limited to, a monocrystalline substrate for illustration purposes. The multi-pore silicon substrate 1 is selected from a group consisting of n-type <100>, n-type <110>, n-type <111>, p-type <100>, p-type <110>and p-type <111>.

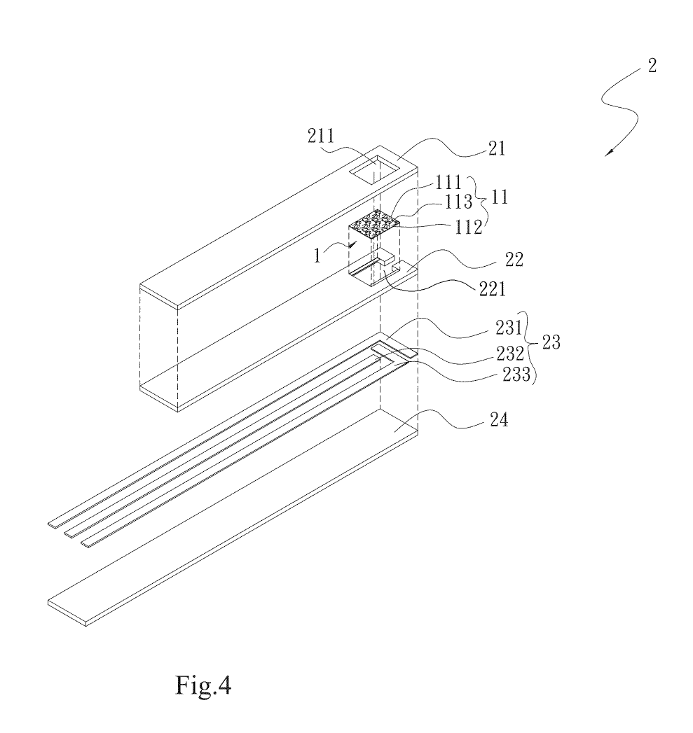

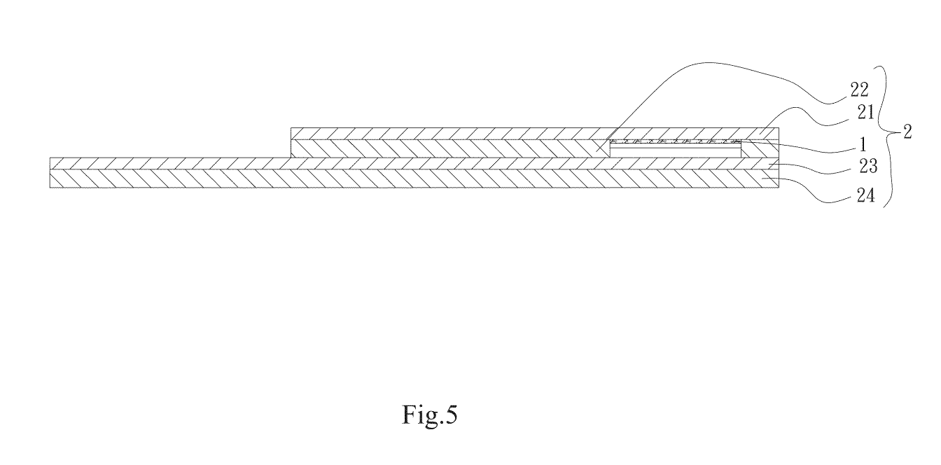

Please refer to FIGS. 4 and 5. FIG. 4 is a perspective exploded view of a preferred embodiment of the biotechnological test strip with the multi-pore silicon substrate of the present invention. FIG. 5 is a sectional assembled view of the preferred embodiment of the biotechnological test strip with the multi-pore silicon substrate of the present invention. As shown in the drawings, the biotechnological test strip 2 with the multi-pore silicon substrate of the present invention includes an upper cover 21, a multi-pore silicon substrate 1, an intermediate layer 22, an electrode layer 23 and a bottom board 24.

The multi-pore silicon substrate 1 includes a main body 11 having a first side 111, a second side 112 and multiple pores 113. The pores 113 pass through the main body 11, respectively. Two ends of the pore 113 communicate with the first and second sides 111, 112 of the main body 11.

The upper cover 21 has a guide-in section 211. The upper cover 21 is disposed on upper side of the first side 111 of the multi-pore silicon substrate 1 with the guide-in section 211 aligned with the multi-pore silicon substrate 1. The intermediate layer 22 has an accommodating section 221 in which the multi-pore silicon substrate 1 is disposed. The intermediate layer 22 is covered by the upper cover 21 and is attached to the upper cover 21. The electrode layer 23 is attached to the intermediate layer 22. The bottom board 24 covers the electrode layer 23.

The electrode layer 23 has a corresponding electrode 231, a reference electrode 232 and a working electrode 233. One side of the intermediate layer 22 is adhesive, whereby the upper cover 21 and the multi-pore silicon substrate 1 can be securely attached to the intermediate layer 22. The other side of the intermediate layer 22 is also adhesive, whereby the electrode layer 23 and the bottom board 24 can be securely attached to the intermediate layer 22.

In this embodiment, the biotechnological test strip 2 with the multi-pore silicon substrate is mainly used to test the biochemical data of blood. The pores 113 of the multi-pore silicon substrate 1 serve to previously filter off the large-molecule structures in the blood, which will interfere with the precision so as to minimize the error rate of the test. In addition, a high-biocompatibility material is selected as the base material, such as silicon and glass. Such material not only can lower the cost, but also is uneasy to have undesired chemical reaction with the acid and alkali materials in the blood. Therefore, the precision of the physiological data can be promoted.

The pores 113 of the multi-pore silicon substrate 1 of the present invention are through pores which pass through the main body 11 between the first and second sides 111, 112, respectively, and the diameter size of each of the pores 113 is adjustable and controllable. Therefore, under both natural gravity and capillary attraction, a tested material can be quickly filtered. In addition, due to the porosity, even the reaction enzyme or other antibodies can be fixed in the pores. Accordingly, the multi-pore silicon substrate 1 can serve as both a filter layer and an enzyme fixing layer. Furthermore, the manufacturing cost of the multi-pore silicon substrate 1 is low so that the multi-pore silicon substrate 1 can be mass-applied to the test strip structure for in vitro diagnosis. In this case, the data obtained from the test of the commercially available in vitro physiological test strip can be more approximate to the result detected by a medical-grade biochemical instrument.

On the other hand, the test principle of the biotechnological test strip 2 with the multi-pore silicon substrate of the present invention is that the blood is dripped into the guide-in section 211 of the upper cover 21. Then, under both natural gravity and capillary attraction, the plasma of the blood is quickly sucked by the multi-pore silicon substrate 1 into the area where the electrode layer 23 is disposed. At this time, the erythrocyte and platelet are isolated on one side of the multi-pore silicon substrate 1 to achieve a filtering effect. In this case, the plasma dropping onto the electrode layer 23 can uniformly have redox reaction with the biocatalyst or enzyme or antibody. Thereafter, the electrode layer 23 generates current signal of the redox reaction, whereby the concentration of the tested material can be deduced from the current signal of the oxidation-reduction reaction.

The present invention has been described with the above embodiments thereof and it is understood that many changes and modifications in the above embodiments can be carried out without departing from the scope and the spirit of the invention that is intended to be limited only by the appended claims.

What is claimed is:

1. A multi-pore silicon substrate comprising a main body, the main body having a first side, a second side and multiple pores, the pores passing through the main body, respectively, two ends of each pore communicating with the first and second sides of the main body.

2. The multi-pore silicon substrate as claimed in claim 1, wherein each pore has a diameter in micrometer order or nanometer order.

3. The multi-pore silicon substrate as claimed in claim 1, wherein the pores are formed by means of electrochemical etching process or electrochemical polishing process.

4. The multi-pore silicon substrate as claimed in claim 1, wherein the multi-pore silicon substrate is a polycrystalline silicon substrate or a monocrystalline silicon substrate.

5. The multi-pore silicon substrate as claimed in claim 1, wherein the multi-pore silicon substrate is selected from a group consisting of n-type <100>, n-type <110>, n-type <111>, p-type <100>, p-type <110>and p-type <111>.

6. A biotechnological test strip with a multi-pore silicon substrate, comprising:
a multi-pore silicon substrate including a main body, the main body having a first side, a second side and multiple pores, the pores passing through the main body, respectively, two ends of each pore communicating with the first and second sides of the main body;
an upper cover having a guide-in section, the upper cover being disposed on upper side of the first side of the multi-pore silicon substrate with the guide-in section aligned with the multi-pore silicon substrate;
an intermediate layer having a accommodating section, the multi-pore silicon substrate being disposed in the accommodating section, the intermediate layer being covered by the upper cover and attached to the upper cover; and
an electrode layer attached to the intermediate layer; and
a bottom board covering the electrode layer.

7. The biotechnological test strip with the multi-pore silicon substrate as claimed in claim 6, wherein each pore has a diameter in micrometer order or nanometer order.

8. The biotechnological test strip with the multi-pore silicon substrate as claimed in claim 6, wherein the multi-pore silicon substrate is a polycrystalline silicon substrate or a monocrystalline silicon substrate.

9. The biotechnological test strip with the multi-pore silicon substrate as claimed in claim 6, wherein the electrode layer has a working electrode, a counter electrode and a reference electrode.

10. The biotechnological test strip with the multi-pore silicon substrate as claimed in claim 6, wherein one side of the intermediate layer is adhesive, whereby the upper cover and the multi-pore silicon substrate can be securely attached to the intermediate layer, the other side of the intermediate layer being also adhesive, whereby the electrode layer and the bottom board can be securely attached to the intermediate layer.

11. The biotechnological test strip with the multi-pore silicon substrate as claimed in claim 6, wherein the multi-pore silicon substrate is selected from a group consisting of n-type <100>, n-type <110>, n-type <111>, p-type <100>, p-type <110>and p-type <111>.
